(19) United States
(12) Patent Application Publication
(10) Pub. No.: US 2005/0219376 A1
(43) Pub. Date: Oct. 6, 2005

(54) Image recording device having several image recording modes

(75) Inventors: Thomas Wittenberg, Erlangen (DE); Wolfgang Heppner, Nurnberg (DE); Stephan Gick, Lichtenfels (DE); Hubert Voellinger, Rastatt (DE); Ulrich Osterland, Berlin (DE); Thomas Belikan, Bretten (DE); Martin Dolt, Knittlingen (DE); Hans Bloss, Heroldsberg (DE); Robert Couronne, Erlangen (DE)

Correspondence Address: LERNER AND GREENBERG, PA, P O BOX 2480, HOLLYWOOD, FL, 33022-2480, US

(73) Assignee: Fraunhofer-Gesellschaft zur Foerderung der angewandten Forschung e.V.

(21) Appl. No.: 11/075,278

(22) Filed: Mar. 8, 2005

(30) Foreign Application Priority Data
Mar. 8, 2004 (DE) 10 2004 011 147.2

(51) Int. Cl. H04N 5/228

(52) U.S. Cl. 348/222.1

(57) ABSTRACT

A more effective larynx or vocal fold examination is facilitated when an image recording device, preferably a color image recording device comprising three modes is made available, a face-recording recording mode with a low recording frequency or image repetition frequency, respectively, but with a high resolution, a further face-recording recording mode with a higher image repetition frequency but with a lower resolution, and a one-dimensional, for example, row-recording mode also having a higher image repetition frequency. By the switchability of the image recording device between those modes the examining doctor is capable of first getting an overview by means of the slower image recording mode, wherein this may also be done in color, as due to the slower recording frequency this mode is not subject to the illumination problems like the high-speed camera.

### 1. FIELD OF THE INVENTION

The present invention relates to image recording devices in general and in embodiments to cameras that are suitable for examinations in the larynx and in particular for the observation of oscillations of the vocal folds or the substitute vocal folds.

### 2. DESCRIPTION OF THE RELATED ART

In Germany, every year approximately 30,000 new patients go to a medical specialist for phoniatrics and paedaudiology due to hoarseness or problems with their voices. Of these new patients, more than half depend on their voice with regard to their profession. In particular teachers, politicians, sales representatives, priests, singers, actors and moderators belong to this group. In particular with educators, impairments of their voices are frequently encountered and are significant above average from the point of view of industrial medicine. In an examination in 1970 with 7 to 8% of a group of examined teachers voice disturbances were was determined. Latest examinations among students of the teaching profession at the University of Essen indicate that almost 30% of them suffered from disturbances of the voice. Also in a questioning in 1994 among male and female teachers 76% indicated that they were vocally impaired sometimes to frequently. The majority of persons in this circle, according to their own statements, also consult a doctor for this reason and are temporarily unable to work.

A substantial component of the following specialist examination is the visual inspection of the organ of vocal origin, i.e. of the larynx. Here, the phoniatrician looks at the larynx located in the throat with the vocal cords by means of a larynx mirror or an endoscope. FIG. 4 shows an endoscopic image of a healthy larynx in breathing position. The “orientation” indicated below the image relates to the point of view of the patient. Through the endoscope the larynx is regarded from the top. The oval, dark area in the middle of the image is the far opened glottis, limited to the right and the left by the vocal folds 900 to be recognized in the image by their V-shape, also known as vocal cords in common parlance. The structures at the edge of the image, like e.g. vestibular folds, arytenoid cartilage on both sides and the epiglottis at the front are less important for the primary voice signal, are, however, important for the pre-phonatorical motorics.

In the resting or breathing state morphological changes in the larynx area, like for example the new formation of benign or malignant tissue, like e.g. adenoids, carcinomas, cysts and granulomas, thickenings of the vocal folds due to strain (vocal nodules) or inflammatory alterations may be recognized as the cause for voice diseases. If the doctor sees no organical changes, then he attributes the hoarse voice to “irregular” oscillations of the vocal folds and gives the diagnosis of “functional disorder”.

While statically morphological changes may be diagnosed directly, i.e. by seeing the same with an endoscope, for examining the vocal fold oscillations technical observation aids, like the videostroboscopy or the use of high-speed cameras, is required, as the visual perception of the examiner can no longer perceive the vocal fold oscillations with 100-400 oscillations per second. Apart from the purely statical examination of the larynx with the help of a rigid or flexible endoscope, nowadays worldwide a stroboscopic method is used. Alternatives, in particular for the examination of vocal fold oscillations, are provided by the methods of videokymography developed in the past 10 years as well as by the use of high-speed cameras, wherein all these methods are explained in more detail in the following.

The traditional examination of the larynx has been performed using a larynx mirror since the 19^{th} century. The same is increasingly being replaced by rigid lens endoscopes (bar optics) or flexible endoscopes (fiberscopes), to which also photo or video cameras may be adapted.

Due to the simple handling with a simultaneous optimum image quality, the larynx is today mainly examined by use of a lens laryngoscope, as it is for example shown in FIG. 5a.

These endoscopes have rigid bar optics with a deviation prism and a deviation angle of 90° or 70° at the light entry (not shown) and two magnification areas. The rigid tube 902 of the endoscope has a diameter of approx. 9 mm and apart from the rigid glass core of the optical channel also receives channels for one or several light lines.

The lens endoscope is pushed through the mouth up to the pharynx posterior wall, as it is indicated in FIG. 5b. Here, the tongue of the patient has to be pulled out in order to keep the view on the larynx clear. With an overhanging epiglottis, the vocal cords can only be observed in the phonation of vowels like /i/ and /a/.

An alternative possibility for examining the larynx is provided by flexible optics, the so-called fiberscope. A fiberscope is for example shown in FIG. 6a. It includes an approx. 3-5 mm strong fiberglass bundle 904 for the light conduction and the optical transmission. Flexible endoscopes have worse optical characteristics with regard to their mapping and magnification capability as compared to rigid endoscopes.

Accordingly, the visible image portion is much smaller or the magnification factor is substantially smaller than with laryngoscopes, respectively.

The flexible endoscope is pushed, after a surface anesthesia of the mucous membrane, through the nose, nose-pharynx and mouth-pharynx area up to about 2 cm above the larynx, as it is shown in FIG. 6b. The approx. 2 cm long rigid tip of the fiberglass bundle may there be moved up and down by about 60° after the insertion.

The flexible endoscope does not substantially impair phonation or articulation. Thus, oscillations of the vocal folds can also be observed during talking. Disadvantages of flexible endoscopes are the reduced illumination and the decreased spatial image resolution.

Conventional optical recording systems, like e.g. film and video cameras, generally have a limited temporal resolution capability with maximum recording frequencies of 25 (PAL) or 30 (NTSC) full images or frames, respectively, or 50 (PAL) or 60 (NTSC) fields or half frames, respectively, per second. This restricted temporal resolution capability is motivated by the visual perception of humans which has a top cutoff frequency of 25 Hz. These recording rates are sufficient in order to sample biomechanical movements with periodical frequencies up to approx. 15 Hz sufficiently accurately, like for example the pulsing of the healthy human heart or the movement by walking.

In medicine, there are some applications with movements, however, whose basic frequencies are above those 25 Hz, and which require a substantially higher temporal resolution in video recording. Examples for this are the walking, running and jumping analysis in orthopedics and sports medicine, the opening and closing movement of heart valves or oscillations of vocal folds during talking or singing. The basic frequency of these vocal fold oscillations is in the range between 100 and 400 Hz during normal talking.

In order to find the suitable temporal resolution capability F of a recording system for any periodical movement with a maximum object frequency f₀, the so-called sampling theorem of Claude Shannon may be used. It indicates that a sufficiently band-limited continuous signal f(t) with a cutoff frequency f₀ with the samples s₁, s₂, . . . , s may be uniquely reconstructed when it was sampled with a sample frequency of F=1/Δt>2 f.

The oscillation frequency f of human vocal folds is, with approx. 100-400 Hz, substantially above the recording frequencies of conventional cameras, however, and may therefore according to the sampling theorem theoretically neither be examined directly nor indirectly with such conventional recording technologies.

For the clinical differential diagnosis of functional voice impairments in addition the short-time variability in the basic frequency (“jitter”) and the amplitude (“shimmer”) is of interest. For this reason, there is not only the minimal requirement of F>2f according to Shannon for an adequate clinical recording technology, i.e. at least double the basic frequency f of the signal to be sampled, but oversampling in the order of magnitude of a factor of 5-10 is additionally required.

In order to record, archive and if applicable automatically analyze human vocal fold oscillations given the indicated technical boundary conditions, in the field of phoniatrics several different recording technologies have been established.

For the examination of vocal fold oscillations a stroboscopic method is most widely known, which is triggered by the voice sound. Generally, the stroboscopic images of vocal folds are recorded during the production of vocal sounds, “phonation”, with a video camera, recorded on videotape and later qualitatively described by a doctor. Two further—newer—methods which are currently both in a phase of clinical evaluation, are the so-called videokymography and the recording of vocal fold oscillations with digital high-speed cameras.

The stroboscopy is the currently most common method for a clinical examination of vocal cord movements. Via a larynx microphone the acoustic signal of a phonation is recorded. By the thus automatically determined basic frequency, an in-phase impulse illumination is generated by a stroboscopy flash lamp. By this, the oscillation of the vocal cords appears to the viewer as a standing image. By a minimum phase shift between the basic frequency of the acoustic signal and the flash illumination of the larynx, the viewer perceives a “virtual”, i.e. seemingly slower motion of the vocal cords.

The stroboscopy is for example described in Schulz-Coulon (1980): Die Diagnostik der gestörten Stimmfunktion, in Archiv für Ohren, Nasen- und Kehlkopfheilkunde, Vol 227, pp. 1-169, Springer Verlag, Berlin, p 53, or in Arnold et al.: Clinical Examination of Voice, Springer Verlag, Wien, p. 49.

The stroboscopy may provide usable results with healthy and slightly impaired voices with a quasi-periodic and symmetric oscillatory response of the vocal cords. Its use is disputed, however, with functionally impaired voices from a medical point of view and impossible from a technical point of view due to the sampling theorem. With an unsuitable flash triggering of the stroboscopy, so-called “aliasing effects” simulate oscillation waveforms that are not really present. In addition to this, in particular periodic and amplitude fluctuations, aperiodic fluctuation behavior and transient processes of the vocal cords can not be detected by stroboscopy. In addition, neither voice entries nor extremely hoarse voices can be registered by stroboscopy, as they are both distinguished by an asynchronous and aperiodic oscillation behavior of the vocal cords.

Since 1978 the use of video cameras has supplemented stroboscopy as a diagnosis and archiving method. Due to the technical restrictions of video cameras, the oscillations of vocal cords are, however, only recorded with a maximum of 30 images or 60 fields per second, respectively, and thus the vocal cord oscillations are undersampled. The archiving of the stroboscopy recordings on videotapes and their later digitizing using high-resolution video frame grabbers enables a subjective assessment of the recordings. A quantitative evaluation of digitized larynx and videostroboscopy recordings is sensible, however, due to the temporal undersampling of the movement only for texture and color components.

In summary, the advantages and disadvantages of videostroboscopy are as follows:

Advantages:

good image quality, high-resolution (approx. 700×500 image points, video norm)
color recordings
simultaneous detection of the oscillation process at the whole glottis
   Disadvantages:
no continuous image sequence (temporal undersampling, violation of the sampling theorem)
realistic (but virtual) mapping of the oscillation only with strictly periodic oscillations
merely subjective assessment of the movement possible
quantitative evaluation only possible after a costly digitizing of the recording
movement artefacts and image blurring by so-called interlacing effects (i.e. spatial interlacing of two temporally successively recorded fields).

“Kymography” is defined by a doctor as a mapping of a one-dimensional movement in a two-dimensional image. In the case of larynx kymography an individual row of an image section is regarded and examined at different points of time. Of the variants of this approach introduced in the past, only the so-called “videokymography” could establish itself and is currently used in several research centers as a supplement for videostroboscopy.

By a cooperation of the university in Groningen with the Dutch company “Lambert Instruments BV” in 1976 a high-speed videokymography system resulted. This is for example described in Svec, Schutte: Videokymographie—High-Speed Line Scanning of Vocal Fold Vibration. Journal of Voice 10 (2), pp. 201-205, in Schutte, Svec, Sram: Videokymography—A Modern Imaging System for Analyzing Regular and Irregular Vibrations, in: Aktuelle phoniatrisch-pädaudiologische Aspekte 1996, Göttingen, pp. 272-274 and in Schutte, Svec, Sram: Videokymographie, Imaging and Quantification of Regular and Irregular Vocal Fold Vibrations, in: Proceedings of the XVI World Congress of Otorhinolaryn-gology Head and Neck Surgery, pp. 1739-1742.

This system is based on a black and white CCD video camera which records only an individual image row (row camera system) instead of frames per image. By the reduction of the frame having 625 or 525 rows, respectively, to a single row, sample rates of up to 7812.5 Hz may be achieved. This row rate is sufficient in order to sample vocal cord oscillations sufficiently highly, only with one single row per image, however. All successively recorded rows are then recorded on a videotape and may subsequently be replaced via a commercial video monitor such that the vertical axis of an image is replaced by the time axis of the recording.

The archiving of the kymography recordings is performed on videotapes, a digitizing is possible.

The advantages and disadvantages of videokymography may be summarized as follows:

Advantages:

relatively good image quality, high-resolution (approx. 500 image points per image row, video norm)
very high recording rate (approx. 8000 Hz), i.e. the sampling theorem (>2f) including an oversampling factor of the order of magnitude of 5 (>5) is fulfilled for oscillation frequencies up to approx. 800 Hz (2·5·800 Hz=8000 Hz)
   Disadvantages:
black and white recordings
detection of the oscillation process only at one position of the glottis
quantitative evaluation only possible after an expensive digitizing of the recording
only allows a subjective assessment
movement artefacts and image blurring by so-called interlacing effects (i.e. spatial interlacing of two temporally successively recorded fields).

High-speed recordings of the oscillating vocal cords were for the first time performed in 1938, as e.g. described in High-Speed Motion Pictures of the Vocal Cords, Bureau of Publication, Bell Telephone Labs, New York, 1937 and in Farnsworth, High-Speed Motion Pictures of the Human Vocal Cords, Bell Telephone Records, Volume 18, pp. 203-208.

Here, an analog high-speed camera system was used in which the films after exposure were first of all developed before they could be viewed with the help of a projector. This technology was experimentally used until the late 60ies of the 20^{th} century, was then replaced, however, by the above-described stroboscopy due to the immense disadvantages of the recording method.

Now, digital high-speed cameras of different assembly types are o the clinical trial stage worldwide and thus offer a supplement for stroboscopic examinations and an alternative for videokymography. For the application of such cameras for the recordings of vocal fold oscillations for the diagnosis and therapy progress control, for example recordings with 4000 images per second and a spatial resolution of 256×256 image points are possible. The recording duration is thus limited by the size of the camera storage. I.e. with a spatial resolution of 256×256 image points and a compression factor of the order of magnitude of 2, for a recording duration of 2 seconds a working memory of 256 megabytes is required. This working memory may be extended, so that also longer recordings are possible, which is, however, not required in clinical routine, as the clinically interesting and diagnostically relevant actions of the vocal folds are generally in orders of magnitude of 300-500 milliseconds.

In the following, the advantages and disadvantages of digital high-speed cameras are summarized:

Advantages:

High recording rates (approx. 4000 Hz), i.e. the sampling theorem (>2f) including an oversampling factor of the order of magnitude of 5 (>5) is fulfilled for oscillation frequencies up to approx. 400 Hz (2·5·400 Hz=4000 Hz)
Simultaneous detection of the oscillation process at the whole glottis.
Digital kymograms may be calculated later at any point of the glottis from stored recordings.
Quantitative evaluation possible directly after storing on a computer.
   Disadvantages:
Average—but acceptable—image quality, i.e. approx. 256×256 image points.
Currently only available as a black and white system for the phoniatric field.
Color-high-speed cameras are technically realized (see e.g. crash-test systems) and wanted by clinics, but have hitherto not been realized for the field of phoniatrics. As such color systems generally require a 2-3 times lighter illumination which correspondingly heats up the pharynx, the same are (a) too dark (normal light source, little heat, high recording rate), (b) too slow (normal light source, little heat, slow recording rate) or (c) too hot (light source with high power, much heat but high recording rate) for the mentioned medical use.

From the above description it may be seen that doctors have up to now no system available which enables them to perform visual examinations at the larynx without any disadvantages. Even if a doctor has all the above-described systems available, i.e. laryngoscopy, stroboscopy, kymography and a digital high-speed camera, he would have to live with all those disadvantages and in addition with a complicated handling of three devices or systems, respectively. There is consequently a demand for a system that enables a more effective image-producing larynx examination.

### SUMMARY OF THE INVENTION

It is therefore the object of the present invention to provide an image recording device facilitating a more effective larynx or vocal fold examination, respectively.

In accordance with a first aspect, the present invention provides an image recording device, having a pixel array of image points; a first image recording mode for an image recording with a first resolution comprising a first number of image points having a first image repetition frequency; a second image recording mode for an image recording with a second resolution comprising a second number of image points having a second image repetition frequency, wherein the first number is higher than the second number and the first image repetition frequency is lower than the second image repetition frequency, wherein the image recording device may be switched between the image recording modes.

In accordance with a second aspect, the present invention provides a device for examining a larynx and oscillating vocal folds, having a light source; an image recording device according to one of the preceding claims, wherein the image recording device comprises an endoscope for conducting light from the light source onto the vocal folds for illuminating and for mapping the reflected light onto the pixel array.

In accordance with a third aspect, the present invention provides a system for examining a larynx and oscillating vocal folds, having a light source; a first image recording device comprising a pixel array of image points; a first image recording mode for an image recording with a first resolution comprising a first number of image points having a first image repetition frequency; a second image recording mode for an image recording with a second resolution comprising a second number of image points having a second image repetition frequency, wherein the first number is higher than the second number and the first image repetition frequency is lower than the second image repetition frequency, wherein the image recording device may be switched between the image recording modes, wherein the first image recording device is color-enabled; a second image recording device comprising a pixel array of image points; a first image recording mode for an image recording with a first resolution comprising a first number of image points having a first image repetition frequency; a second image recording mode for an image recording with a second resolution comprising a second number of image points having a second image repetition frequency, wherein the first number is higher than the second number and the first image repetition frequency is lower than the second image repetition frequency, wherein the image recording device may be switched between the image recording modes, wherein the second image recording device is non-color-enabled but is more light-sensitive than the first one; and at least one endoscope for conducting light from the light source onto the vocal folds for illuminating and for mapping the reflected light onto the pixel array of the first or the second image recording device.

It is the finding of the present invention that a more effective larynx or vocal fold examination, respectively, is facilitated if an image recording device, preferably a color image recording device or color camera, respectively, with at least two of three modes is available, i.e. (a) having a laminarly recording recording mode with a low recording frequency or image repetition frequency, respectively, but with a high spatial image resolution, (b) a further laminarly recording recording mode with a higher image repetition frequency but with a lower spatial image resolution, and (c) a one-dimensional, for example row recording mode also with a higher image repetition frequency.

With a switchability of the image recording device between the three modes the examining doctor is able to get an overview first of all by means of the slower image recording mode (laryngoscopy). Then the doctor may, with the also laminarly recording but faster recording mode, perform a first evaluation of a slow motion of the vocal fold movement. Based on this recording the doctor may then, as required, also perform a kymography by means of a one-dimensionally recording image recording mode, wherein he may, due to the possibility of switching between the modes, align the sampling line suitably with regard to the vocal cords such that the sample line is arranged at a suitable place with regard to the vocal cords. The cooperation of all three modes and the switchability consequently enables an unproblematic larynx and vocal fold examination in all respects. With a missing third recording mode a kymogram may alternatively be generated from the faster recording in the second recording mode, when a row is taken out of the two-dimensional field.

### BRIEF DESCRIPTION OF THE DRAWINGS

In the following, preferred embodiments of the present invention are explained in more detail with reference to the accompanying drawings, in which:

FIG. 1 is a block diagram of a laryngoscopy system according to an embodiment of the present invention;

FIG. 2 is a schematical drawing of the camera in the system of FIG. 1 according to an embodiment of the present invention;

FIG. 3 is a schematical drawing of the pixel array of the camera of FIG. 2 for illustrating the different areas of image points that are used in the individual image recording modes of the camera according to one embodiment of the present invention;

FIG. 4 is an endoscopy image of a healthy larynx in breathing position;

FIG. 5a is a stereoscopic image of a rigid endoscope;

FIG. 5b is a schematical drawing for illustrating the use of the rigid endoscope of FIG. 5a for examining the larynx;

FIG. 6a is an image of a fiberscope;

FIG. 6b is a schematical drawing for illustrating the use of the fiberscope of FIG. 6a for examining the larynx.

### DESCRIPTION OF THE PREFERRED EMBODIMENTS

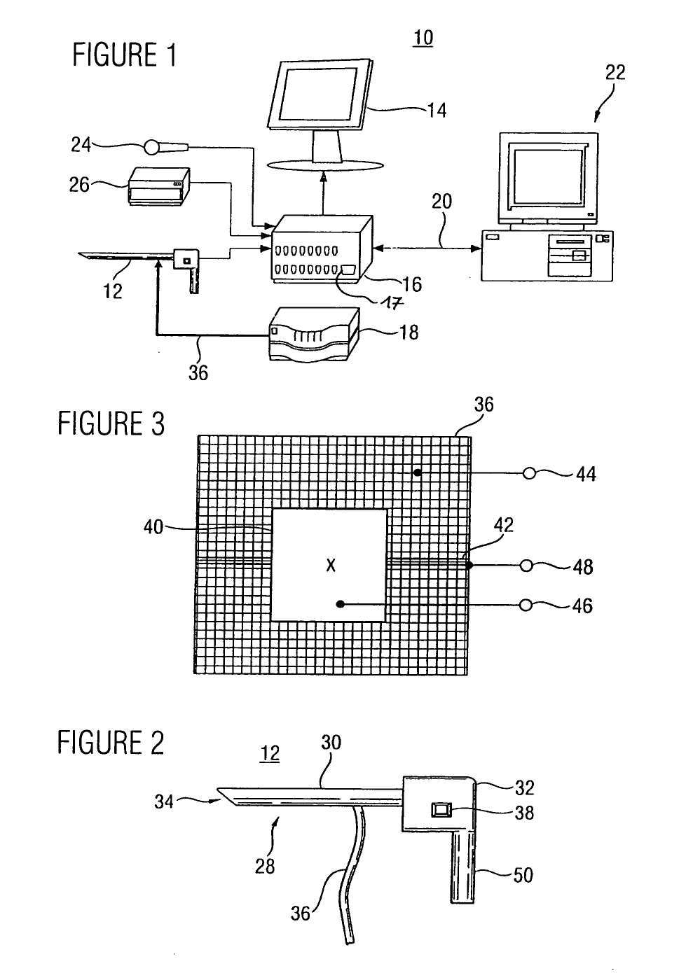

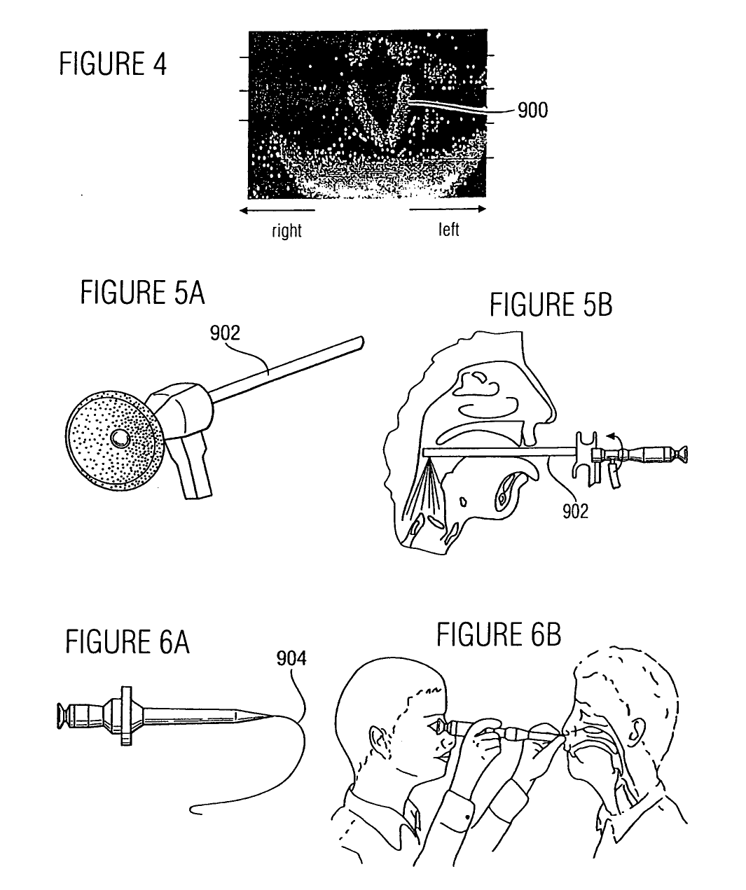

FIG. 1 shows a device for examining the larynx or the vocal folds, respectively, according to one embodiment of the present invention. The system which is generally indicated as 10 includes a camera 12 whose setup is explained in more detail in the following with reference to FIG. 2, a video monitor 14 for example having a standard PAL or NTSC input, a control device 16 having a digital image storage 17 and a light source 18. The control device 16 may further be connected to a computer 22 via a network, like e.g. an ethernet connection 20. Further, other external devices may be connected to the control device, like e.g. a microphone 24 and an EGG device 26, wherein, however, alternatively or additionally also other devices may be connected.

FIG. 2 illustrates the camera 12 in more detail. According to the embodiment of FIG. 2, the camera 12 is provided with a rigid endoscope top 28 with rod optics 30 which is provided, as described with reference to FIG. 5b, to be inserted into the pharynx area of the patient through the opened mouth. At a coupling side of the endoscope 28 the same may be coupled to a camera head 32. At the other distal end of the endoscope 28 the optical opening 34 is located via which the light reflected by the larynx reaches the camera head 32. The optical opening 34 is further provided to enable light for illuminating the larynx or the vocal folds to pass through to the latter, wherein the light is supplied from the light source 18 via a light conductor 36 that may be coupled to the endoscope 28. The optics of the endoscope 28 map the larynx or the vocal folds, respectively, to be examined to a light-sensitive area or a light-sensitive face of the camera head 32, respectively, that is mapped by a pixel array which is for example implemented as a CMOS chip.

FIG. 3 exemplarily shows the pixel array 36 of the camera 32. It exemplarily includes 512×386 image points. In FIG. 3, for reasons of clarity, the pixel array 36 is only represented as the face that the image points of the pixel array occupy and not as the amount of the image points or pixels, respectively, which are regularly arranged in rows and columns. In FIG. 3, a small cross “x” indicates the point on the face of the pixel array 36 in which an optical axis of the camera 12 or the mapping optics 28, respectively, intersect the pixel array.

The camera is switchable by an operating element 38, like e.g. an operating key, a button, a rotary switch, a toggle switch or the like, between three operating or image recording modes, respectively. In a first image reception mode the camera records images with a slow image repetition frequency or recording frequency, respectively, of for example 20-1000 Hz or of only 20-100 Hz, preferably 25 Hz or 30 Hz, i.e. with a resolution that includes all 512×386 image points of the pixel array 36. In a second image recording mode the camera records images with a higher speed, i.e. for example with a speed of 1000 to 4000 Hz, wherein, however, for recording only the image points within a preferably rectangular partial area 40 of about 200×200 to 500×500 and preferably 256×256 image points is used, wherein the partial area 40 is substantially arranged centrally, i.e. in the middle of the optical axis. In a third image recording mode the camera 12 records images with an even higher image repetition frequency of higher that 4000 Hz, like e.g. 8000 Hz, uses, however, only one image point line for this, like e.g. one row of 512 image points of the pixel array 36, wherein the image row is indicated as 42 and preferably runs through the optical axis x. The pixel array 36 consequently includes an output 44 for outputting the image data in a first recording mode which is provided for laryngoscopy, i.e. the normal examination of the larynx, an output 46 for outputting the image data in the second image recording mode provided for high-speed recordings, and an output for outputting the image data in the third image recording mode provided for the digital kymography. The outputs 44-48 do not have to be physically separated outputs but may also be formed by one output. In the case of the implementation by a CMOS sensor array, the realization of the different readout areas 36, 40 or 42, respectively, is achieved by the individual addressability of the image point or sensor elements, respectively. With regard to the size of the pixel array 36 also a different size than 512×386 image points, like e.g. 1000×1000, is possible. It would further be possible only to use a partial area of the overall pixel array as the pixel area for the first image recording mode.

As the setup of the system 10 and also of the camera 12 has been described in more detail above, in the following its functioning as well as the functioning of the camera 12 within the system 10 is described.

When the system 10 is switched on, the camera 12 is for example as a default first located in the slow frame mode.

If the endoscope 28 has not been plugged onto the camera head 32 then this may be made up for. By a special adapter (not shown in FIG. 2) on the camera 12, like for example a snap-on or plug-in technology, for the recording endoscopes of different types may be used, although in FIG. 2 as an example only a rigid endoscope is shown. Thus, also fiberendoscopes may be used and alternatively also 90° and 70° endoscopes or zoom endoscopes. As soon as camera head 32, light conductor 36 and endoscope 28 are connected to each other, a first digital video laryngoscopy may be performed, i.e. a recording of the larynx. The recording is performed according to the first operation mode with a resolution of the present example of 512×386 image points in color for individual images and a recording speed of 25-30 images/second for image sequences. The pixel array 36, in this slow frame mode, outputs the data via the output 44 via a data line directly to the control device 16 in the digital image storage 17 which again outputs the data—possibly after a suitable reconverting into one of the standard formats PAL or NTSc, respectively—to the video monitor 14. The doctor may thus look at the larynx via the monitor 14 during the examination.

Via the operating element 38 on the camera 12, the doctor may then perform a digital high-speed recording, e.g. presently as an example with a resolution of 256×256 image points in color or black and white with a recording speed of for example 4000 images/second. As the operating element 38 is arranged on the camera 12 the doctor may perform the switching without a further movement and is therefore not at risk of changing the camera or the endoscope in their alignment while performing the mode change. The operating element is preferably arranged in a grip area 50 of the camera so that the operator, i.e. the doctor, may perform a switching without changing sides and without the use of a second hand.

After switching, the pixel array 36 outputs the data of the field 40 to the output 46 via the data line to the control device 16. There, they are stored in the digital image storage 17. It is possible that the control device 16 also performs a conversion of the image data into a suitable video format in order to illustrate the image sequence either as slow motion or in real time by omitting some images on the monitor 14 with the monitor playback frequency.

Based on the observation of the high-speed glottography the doctor may then decide to perform a digital video kymography by again suitably operating the operating element 38. In this image recording mode the camera 12 records images with a resolution of 512×1 image points, i.e. per temporal sampling unit one row of image points is read out. The recording is performed in color or black/white with a recording speed of presently as an example 8000-10000 images/second or more. Via the output 48 the pixel array 36 outputs the image data of the image row 42 via the data line to the control device 16. There, they are stored in the digital storage 17.

All the data stored in the image storage 17 that resulted during a recording by one of the three recording modes (laryngoscopy, high-speed recording or kymography) may be passed on from the control device 16 via the connection 20 to the computer 22 for archiving. On this computer 22 a suitable software (not shown) provides a suitable indication and evaluation of the archived image data. On the computer 22 the doctor may for example put an intersection line across a still picture from the sequence via the program for the high-speed image sequences which runs transverse to the vocal folds in order to have a digital kymogram established and illustrated along the corresponding pixel line.

The kymography images omitted in the single-row mode or the digital kymogram data established by the program from the high-speed recordings, i.e. the respectively subsequent image rows, may be illustrated and analyzed on the computer.

Preferably, the camera 12 operates such that the video and high-speed recordings are generated in the two face-recording image recording modes in a so-called “progressive scan” mode, i.e. in a way in which all image points of a frame at a point of time are recorded simultaneously and not, as it is known from television technology, in an “interlacing” mode with a row-wise interlacing of two temporally subsequently recorded fields. In this way, the movement artefacts resulting by interlacing are prevented.

The doctor has further the possibility to have data streams, like e.g. measurement data or the like, synchronized by connected external devices 24 and 26 and have them recorded simultaneously to the image recordings and have them archived. To this end, the control device 16 includes a synchronization means that synchronizes the data streams of the external devices 24, 26, like e.g. the acoustic signal or audio signal, respectively, of the microphone 24 or the electroglottogram (EGG), with the images of the image recording. Further external devices may for example be a speed sensor. A further exemplarily externally supplied signal might for example be a data stream of serial sound level values.

Via the PC 22, for which no special hardware is required, the transmission, storing and archiving of the video sequences of the video laryngoscopy, the high-speed recordings of the high-speed glottography and the videokymograms of the videokymography and additionally as required individual still pictures take place.

Within the PC 22 the recorded data, i.e. the image data and if applicable the audio- or electroglottogram data, respectively, may be evaluated using a method of digital image and signal processing, which is for example implemented in a suitable software running on a PC. From the high-speed recordings of the faster face-recording image recording mode for example descriptive parameters for describing the vocal fold oscillation may be calculated, like e.g. an opening and closing quotient, basic frequency right and left, transient and decay time right and left, etc. These values may then among others be correlated with values from the audio recording and the EGG recording. From the high-resolution color laryngoscopy recordings, i.e. the recordings in the slower full-image mode, with the help of color texture methods for example diagnosis proposals for the incidence leucoplakia as a cancer pre-stage may be calculated.

The above-described system is consequently superior to all currently conventional systems. In current clinical practice morphology, the texture and the color of the larynx is diagnosed by video laryngoscopy, the analysis of the coarse and fine movements of the vocal folds, however, is performed by the sub-optimum videostroboscopy. In some European, Japanese and US American clinics and centers, in addition, for a differential diagnosis of the vocal fold oscillation an additional time-consuming recording with a further system is performed, either with a digital high-speed camera or with a videokymography system. The above-described embodiment of a device for a larynx and vocal cord examination, however, provides a combined multifunctional camera device for an objectivized voice diagnosis and in particular the integration of a switchable digital (colored) video laryngoscopy system with a digital (color) high-speed camera, wherein also the recording of digital (color) videokymograms is facilitated.

With reference to the description above, the following is to be noted. Although it was described above that the operation unit is mounted on the camera head itself, it may further be intended that the switching of the camera between the individual operation modes is performed for example via the keyboard (not illustrated) of the PC 22 or the microphone 24 or a pedal switch (not shown). Further, the sensor face for the laryngoscopy 36, the sensor row for the digital kymography 42 and the sensor face 40 for the high-speed recordings may also be arranged differently. It is further to be noted that when coupling a stroboscopic light source it would also be possible to perform a videostroboscopy with the above described device.

It is to be noted that the above-described camera is not suitable for an examination of vocal folds, but in general for the examination of objects moving with a high frequency, like e.g., apart from vocal folds, also for the examination of artificial or natural heart valves or also the time-triggered recording of voice replacements after a larynx removal.

It is further to be noted that the above embodiment was only a preferred embodiment in so far that it described a camera with three operation modes. The camera offers even advantages as compared to former systems, however, if only two or three of the above-described modes are implemented.

With reference to the preceding description it is also to be noted that the system according to FIG. 1 may also be provided with two different camera heads, i.e. a color-enabled one with a color camera and a non-color-enabled one with a black and white camera having a stronger illumination. Optionally, one of the two camera heads might be connected to the control device. Both camera heads would preferably be optionally connectable to one of two endoscopes that would be contained in the system, i.e. a bar endoscope and a fiberscope. It would further be possible, however, that the non-color-enabled but more light-sensitive camera head is firmly provided with the fiberscope, while the other color-enabled camera head is provided with the bar endoscope. The provision of such an equipment would have the advantage for the system of FIG. 1, that when using the fiberscope the thus conditioned poor illumination can be balanced by the higher light sensitivity of the black and white camera head when color information is abandoned, while when using the bar endoscope the comparatively increased illumination can be used in order to be able to use the color-enabled camera head.

It is further to be noted with regard to the preceding description that, however, in the preceding description a difference was made between the camera head on the one hand and the endoscope top part on the other hand, but that this differentiation may become superfluous, however, when the above-mentioned CMOS or CCD sensor is for example directly integrated into the endoscope in order to result in an image recording device that is firmly coupled to the endoscope. Here, the sensor chip on the endoscope may both be arranged distally, i.e. at the front end of the endoscope facing the larynx or at the endoscope tip, respectively, and also proximally, i.e. at the end of the endoscope facing the doctor. The above-mentioned camera head is hereby reduced to only one operation of a thus resulting image recording device in which the light-sensitive pixel array is integrated into the endoscope.

Finally it is to be noted with regard to FIG. 1 that the storage 17 may also be arranged in the camera head.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

This application claims the priority, under 35 U.S.C. § 119, of German patent application No. 10 2004 011 147.2, filed Mar. 8, 2004; the entire disclosure of the prior application is herewith incorporated by reference.

1. An image recording device, comprising:
a pixel array of image points;
a first image recording mode for an image recording with a first resolution comprising a first number of image points having a first image repetition frequency;
a second image recording mode for an image recording with a second resolution comprising a second number of image points having a second image repetition frequency, wherein the first number is higher than the second number and the first image repetition frequency is lower than the second image repetition frequency,
wherein the image recording device may be switched between the image recording modes.

2. The image recording device according to claim 1, wherein the first image recording mode is implemented such that the image recording with the first resolution comprises a two-dimensional field of the first number of image points and wherein the second image recording mode is implemented such that the image recording with the second resolution comprises a two-dimensional field of the second number of image points.

3. The image recording device according to claim 2, wherein the first image repetition frequency is between 20 and 1000 Hz, and wherein the second image repetition frequency is larger than 1000 Hz.

4. The image recording device according to claim 2, wherein the first number is approximately 350×350 to 1000×1000 and the second number is approximately 200×200 to 500×500.

5. The image recording device according to claim 1, wherein the first image reception mode is implemented such that the image recording with the first resolution comprises a two-dimensional field of the first number of image points and wherein the second image reception mode is implemented such that the image reception with the second resolution comprises a one-dimensional field of the second number of image points.

6. The image recording device according to claim 5, wherein the first image repetition frequency is between 10 and 1000 Hz and the second image repetition frequency is larger than 4000 Hz.

7. The image recording device according to claim 5, wherein the first number is approximately 350×350 to 1000×1000 and the third number is 350×1 to 1000×1.

8. The image recording device according to claim 5, wherein the first number is smaller than a number of pixels of the pixel array that may be read out.

9. The image recording device according to claim 8, wherein the first image repetition frequency is between 1000 and 4000 Hz and the second image repetition frequency is larger than 4000 Hz.

10. The image recording device according to claim 8, wherein the first number is approximately 200×200 to 500×500 and the third number is 350 to 1000.

11. The image recording device according to claim 1, wherein the first image recording mode is implemented such that the image recording with the first resolution comprises a two-dimensional field of the first number of image points and wherein the second image recording mode is implemented such that the image recording with the second resolution comprises a two-dimensional field of the second number of image points, wherein the image recording device further comprises:
a third image recording mode for an image recording with a third resolution comprising a one-dimensional field of a third number of image points with a third image repetition frequency, wherein the third number is smaller than the first number and the third image repetition frequency is higher than the first image repetition frequency,
wherein the image recording device may be switched between the three operational modes.

12. The image recording device according to claim 11, wherein the first image repetition frequency is between 20 and 1000 Hz, the second image repetition frequency is between 1000 and 4000 Hz and the third image repetition frequency is larger than 4000 Hz.

13. The image recording device according to claim 11, wherein the first number is approximately 350×350 to 1000×1000, the second number is approximately 200×200 to 500×500 and the third number is 350×1 to 1000×1.

14. The image recording device according to claim 1, wherein the third image repetition frequency is larger than the second image repetition frequency.

15. The image recording device according to claim 1, wherein an extension of the two-dimensional field of the first number of the image points is larger than the extension of the two-dimensional field of the second number of the image points.

16. The image recording device according to claim 1, wherein the two-dimensional field of the first and the second number is arranged about centrally to an optical axis of the image recording device.

17. The image recording device according to claim 1, further comprising:
an endoscope for mapping vocal folds or other objects moving with a high frequency, like for example heart valves, onto the pixel array.

18. The image recording device according to claim 1, that is suitable for a temporally resolved recording of oscillating vocal folds, of natural or artificial heart valves or for a temporally resolved recording of a voice replacement after a larynx removal.

19. The image recording device according to claim 1, further comprising:
an operating element for switching the image recording device between the image recording modes.

20. The image recording device according to claim 1, wherein the pixel array is a color pixel array.

21. A device for examining a larynx and oscillating vocal folds, comprising:
a light source;
an image recording device according to one of the preceding claims, wherein the image recording device comprises an endoscope for conducting light from the light source onto the vocal folds for illuminating and for mapping the reflected light onto the pixel array.

22. The device according to claim 21, comprising:
a controller coupled to the image recording device and which may be coupled to an external device, wherein the controller further comprises:
synchronizer for synchronizing a data stream from the external device with the image recording.

23. The device according to claim 21, comprising:
an image storage for buffering the image data between recording and archiving.

24. The device according to claim 23, wherein the image storage is arranged externally to the image recording device in a controller coupled to the image recording device.

25. The device according to claim 21, wherein the image recording device is an image recording device according to claim 5, further comprising:
a controller coupled to the image recording device for indicating a kymogram of the image recording mode with a resolution comprising the one-dimensional field.

26. The device according to claim 21, wherein the image recording device is an image recording device according to claim 1 and 11, and further comprising:
a controller coupled to the image recording device to enable that a user determines an image point line from the two-dimensional field of the second number from the second image recording mode and for generating and indicating a kymogram of image data of the second image recording mode with regard to the indicated image point line.

27. The device according to claim 21, wherein the first image recording mode of the laryngoscopy, the second image recording mode for a high-frequency image recording and the third image recording mode serve for kymography.

28. The device according to claim 21, wherein the pixel array of the image recording device is arranged either distally or proximally within the endoscope.

29. A system for examining a larynx and oscillating vocal folds, comprising:
a light source;
a first image recording device comprising a pixel array of image points; a first image recording mode for an image recording with a first resolution comprising a first number of image points having a first image repetition frequency; a second image recording mode for an image recording with a second resolution comprising a second number of image points having a second image repetition frequency, wherein the first number is higher than the second number and the first image repetition frequency is lower than the second image repetition frequency, wherein the image recording device may be switched between the image recording modes, wherein the first image recording device is color-enabled;
a second image recording device comprising a pixel array of image points; a first image recording mode for an image recording with a first resolution comprising a first number of image points having a first image repetition frequency; a second image recording mode for an image recording with a second resolution comprising a second number of image points having a second image repetition frequency, wherein the first number is higher than the second number and the first image repetition frequency is lower than the second image repetition frequency, wherein the image recording device may be switched between the image recording modes, wherein the second image recording device is non-color-enabled but is more light-sensitive than the first one; and
at least one endoscope for conducting light from the light source onto the vocal folds for illuminating and for mapping the reflected light onto the pixel array of the first or the second image recording device.

30. The system according to claim 29, wherein the endoscope may optionally be effectively coupled to the first or the second image recording device.

31. The system according to claim 29, wherein the endoscope is a rigid endoscope, and further comprising a fiberscope, wherein both may optionally be effectively coupled to the first or the second image recording device.

32. The system according to claim 29, wherein the endoscope is a rigid endoscope, and further comprising a fiberscope, wherein the rigid endoscope is firmly effectively coupled to the first image recording device, while the fiberscope is firmly effectively coupled to the second image recording device.
